(19) United States
(12) Patent Application Publication
(10) Pub. No.: US 2006/0167871 A1
(43) Pub. Date: Jul. 27, 2006

(54) Method and system for blocking specific network resources

(76) Inventors: James Lee Sorenson, Salt Lake City, UT (US); Michael Drew Flathers, Alpine, UT (US); Edward Franz Armstrong, American Fork, UT (US); Scot Lorin Brooksby, Highland, UT (US)

Correspondence Address: TRASK BRITT, P.O. BOX 2550, SALT LAKE CITY, UT, 84110, US

(21) Appl. No.: 11/015,585

(22) Filed: Dec. 17, 2004

(51) Int. Cl. G06F 17/30; G06F 7/00

(52) U.S. Cl. 707/6

(57) ABSTRACT

A system and method for blocking access by a network device to specific network resources by comparing a specific resource identifier against entries in a blacklist and facilitating a connection accordingly. A request for a connection to a specific network resource identified by a specific identifier is received and compared against entries in a stored blacklist. When the specific identifier matches one of the entries within the blacklist, the connection to the specific network resource is denied and when the specific identifier does not match one of the entries within the blacklist, then the connection to the specific network resource is allowed. The system further includes a blacklist database that maintains an updated copy of the blacklist and the network device retrieves an updated version upon the occurrence of specific events.

### BACKGROUND OF THE INVENTION

1. Field of the Invention

The invention relates generally to access control in a communication system and, more particularly, to a method and system for blocking access to specific wide area network addresses in a communication system.

2. State of the Art

Conventional telephony services are generally provided over circuit-switch networks commonly known as Public Switched Telephone Networks (PSTN). For calls originating over the PSTN, a connection is formed between the calling party and the called party that is exclusive to all other users. When the established call is completed, the connection is opened and the corresponding lines are available for the establishment of a subsequent call through a connection and reuse of one or more lines.

Currently, there is a growing migration from communications which are based over the PSTN toward communication which are based over a connectionless network such as the Internet wide area network. Such communication over the Internet is commonly known as Internet telephony and is further commonly known as Voice-over-IP (VoIP). Internet telephony is a service provided over an IP network such as a packet switched network. Internet telephony recognizes efficiencies in transmitting packets carrying data for communication between a called and a calling party over a network without reserving or dedicating specific connections between the parties for the duration of the call. Such an approach digitizes audio signals and packetizes them into packets for transmission across the IP-based network. On the receiving end, the packets are depacketized and the data is transformed into audio for playback for the receiving party.

Since the data is carried digitally across the IP network, other information such as video data may be incorporated into Internet telephony without substantial modifications. Due to the ease of integrating audio and video data into Internet telephony, video phones are becoming more ubiquitous. Additionally, services, an example of which are interpretive sign language services for the hearing impaired, are also made available through the utilization of video phones by making the transmission of video imaged sign language expressions transmittable over an Internet telephony system.

Accordingly, significant capital investments into the development and manufacturing of improved video telephony devices has become more commonplace. As investment in equipment development and services increases, equipment manufacturers and service providers have an economical interest in encouraging selection of their equipment and services by a consumer. It is not uncommon in commercial applications for service providers to make available to customers equipment at a competitive or even subsidized rate for utilizing their services. Therefore, there is motivation for Internet telephony equipment providers to safeguard their equipment from being utilized by services that are not associated with an equipment provider. While such a motivation is specific, more general motivations exist for preventing or blocking access by an Internet device such as a videophone to undesirable, rogue or competitive services or locations on the network.

### BRIEF SUMMARY OF THE INVENTION

A method and system for blocking network resources is provided. In one embodiment of the present invention, a method for blocking access to specific network resources is provided. The method receives a request for a connection to a specific network resource as identified by a specific identifier. The specific identifier is compared against entries in a stored blacklist while the blacklist includes blocked network resource identifiers. When the specific identifier matches one of the entries within the blacklist, the connection to the specific network resource is denied and when the specific identifier does not match one of the entries within the blacklist, the connection to the specific network resources is allowed.

In another embodiment of the present invention, a network device is provided. The network device includes a first portion of storage configured to retain a list of entries in a stored blacklist with the blacklist including blocked network resource identifiers. The network device further includes a control process configured to receive and compare a request for a connection to a specific network resource as identified by a specific identifier. The comparison is made with the list of entries in the stored blacklist which include the blocked network resource identifiers. The control process is further configured to deny the connection to the specific network resource when the specific identifier matches one of the entries within the blacklist. The control process is further configured to allow the connection to the specific network resource when the specific identifier does not match one of the entries within the blacklist.

In a further embodiment of the present invention, a system for selectively blocking access to specific network services is provided. The system includes a network device which further includes storage configured to store entries in a stored blacklist which includes blocked network resource identifiers. The network device further includes a control process configured to receive and compare a request for a connection to a specific network resource as identified by a specific identifier. The comparison is made against the list of entries in the stored blacklist including blocked network resource identifiers. The control process is further configured to deny the connection to the specific network resource when the specific identifier matches one of the entries within the blacklist and to allow the connection to the specific network resource when the specific identifier does not match one of the entries within the blacklist. The system further includes an associated service preferably selected by the network device which is identified by a stored service number located within the network device which identifies the associated service. The system additionally includes a network for selectively addressably coupling the network device with the associated service.

### BRIEF DESCRIPTION OF THE SEVERAL VIEWS OF THE DRAWINGS

In the drawings, which illustrate what is currently considered to be the best mode for carrying out the invention:

FIG. 1 illustrates an IP-based communication system incorporating an exemplary service, in accordance with an embodiment of the present invention;

FIG. 2 illustrates a simplified block diagram of a communication system configured for interacting with a video phone, in accordance with an embodiment of the present invention;

FIG. 3 is a block diagram illustrating details of an access control or blacklist, in accordance with an embodiment of the present invention;

FIG. 4 is a flow diagram of a power up sequence of an IP device, in accordance with an embodiment of the present invention;

FIG. 5 is a flow diagram of a blacklist update process of an IP device, in accordance with an embodiment of the present invention; and

FIG. 6 is a flow diagram of an IP device call initiation process configured to block access to specific network entities, in accordance with an embodiment of the present invention.

### DETAILED DESCRIPTION OF THE INVENTION

Generally, IP devices may access essentially all IP addressable network elements. However, for various reasons, there are certain applications where access to specific resources identified by an IP address would be preferably denied. By way of example, and not limitation, one exemplary IP device may be a video phone which may be deployed to a user at a full, subsidized or reduced fee in conjunction with offered services. In such an example, it would be inherently disadvantageous to allow a user to circumvent utilization of an associated service coupled to a deployed IP device when such an agreement or understanding to the contrary exists. Additionally, it may also be advantageous for the protection of users of IP devices to be protected from unethical or immoral resources identified by one or more specific IP addresses. Therefore, the various embodiments of the present invention utilize a list of current IP addresses and/or domain names uniquely identifying a particular network resource causing the IP device to be incapable of connecting or interacting with the identified or blacklisted resource or device.

By way of example, and not limitation, various embodiments of the present invention are disclosed in conjunction with a specific network resource identified herein as a video service, more specifically, the exemplary video service may be configured as a translation video service for assisting in communication with the hearing impaired. While such a specific service is illustrative, it is by no means to be interpreted as limiting of the scope of the present invention. Furthermore, the use of the terms “service” and “network resource” are not to be considered as limiting of specific services but rather also includes any network addressable device, resource, web page, or other entity uniquely selectable by an IP address or domain name or other network addressing mechanism.

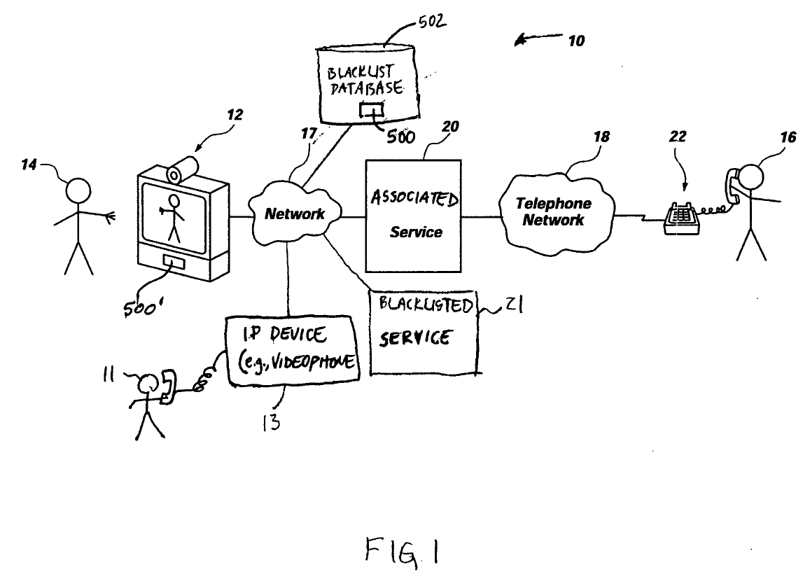

FIG. 1 illustrates an IP-based communication system, in accordance with an embodiment of the present invention. As stated, the present example includes an exemplary IP-based service depicted as a translation service for the hearing impaired while the scope of the present invention is not so limiting. The use of such a specific example is for illustrative purposes and is not to be construed as being limiting of the invention which finds broader application to all IP services. A communication system 10 enables a user 14 (e.g. a hearing impaired user) to engage in conversation through a communication system with a user 11 through the use of IP devices 12, 13. The communication system 10 may also enable a user 14 to engage in conversation through a communication system with a user 16 via a specific network service such as an associated service 20. A communication session between the users is facilitated through the use of various equipments, which are preferably coupled together using various networks.

To interface a user 14 with a user 11, a network 17 accommodates the coupling of an IP device 12 with a different IP device 13. In the specific service application as described herein, a hearing impaired user may be interfaced with a generally voice-based communication system through associated services 20 (e.g., interpretive services) allowing the hearing impaired user to communicate with an interpreter, namely through engaging in the act of sign language. The sign language images are then translated by the associated service 20 and when translated into voice information, are then forwarded over a voice-based communication connection to a hearing-capable user 16. One means for relaying the communicative expressions of a user 14 (e.g. a hearing impaired user) within communication system 10 incorporates an IP device 12 configured as a video phone for capturing the communicative expressions exhibited by user 14 (e.g. a hearing-impaired user) and for displaying as received, interpreted voice information originating from the user 16 (e.g. a hearing-capable user).

In the present exemplary illustration, expressions, such as sign language and/or body language, may be interpreted or translated by associated services 20. Additionally, user 16 interacts in the conventional manner with the associated service 20 through the use of a voice-based dialogue conveyed over a conventional voice phone 22. The various devices, such as IP device 12 and conventional voice phone 22 are coupled to the associated service 20 using one or more networks 17, 18. To facilitate the enhanced bandwidth needs of IP device 12, network 17 may be implemented as a high bandwidth network such as a wide area network, an example of which is the Internet. The conduit for coupling an IP device with the network 17 may further include an Internet Service Provider (ISP), the details of which are not shown herein but are known by those of ordinary skill in the art. Network 18 may be implemented according to the standards and bandwidth requirements of a conventional voice phone 22.

In accordance with one or more embodiments of the present invention, the IP device 12 may be configured to prevent access by user 14 to unauthorized or blacklisted services. In the communication system 10, a blacklist database 502 is coupled to the IP device 12 through network 17. Upon the occurrence of an event or other required condition, IP device 12 through network 17 accesses the blacklist database 502 to retrieve a blacklist 500 containing identifiers (e.g. IP addresses and/or domain names) of services or IP devices that are otherwise blocked from being accessed by the IP device 12. As illustrated, the blacklist may include an IP address, domain name, or other identifier which uniquely addresses a specific network resource such as a blacklisted service 21. On the retrieval of the blacklist 500 and evaluation of the stored blacklist 500′ within the IP device 12, access to, for example, the blacklisted service 21 would be denied. In one example, the blacklisted service 21 may be a competitive service to the associated service 20 and the incorporation of the blacklist 500′ and the evaluation thereof by IP device 12 prior to the initiation of a service request or attempted connection with a blacklisted IP device would be prohibited. It should be noted that the blacklist 500′ may contain an identifier to a blacklisted service, or blacklisted IP device, an example of which may be IP device 13 which is determined to be a device to which IP device 12 is not authorized to interact with.

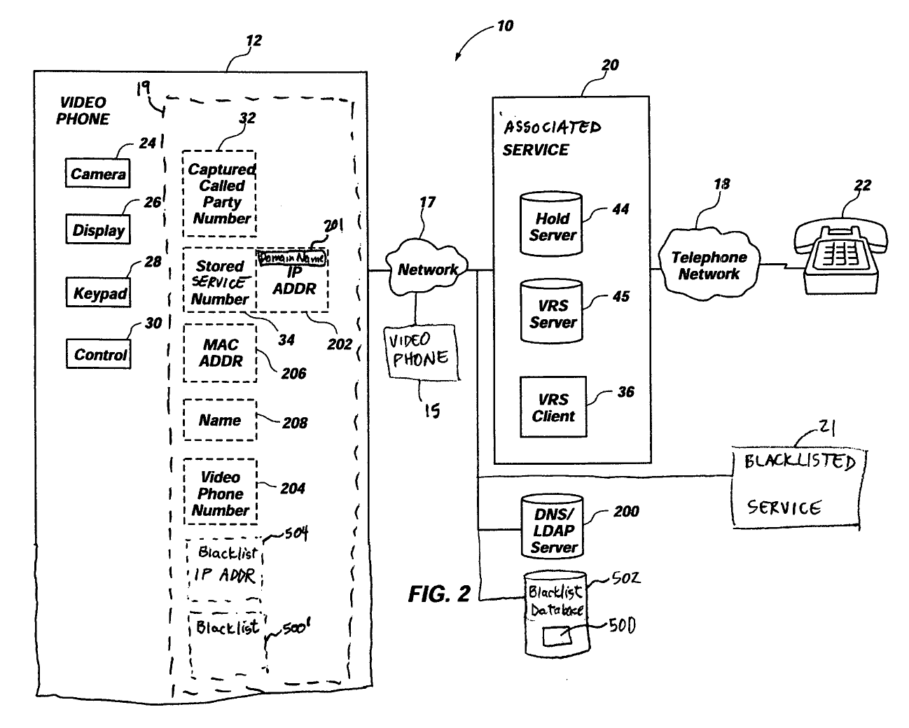

FIG. 2 is a simplified block diagram of a communication system configured for restricting access of an IP device to other IP devices or services, in accordance with an embodiment of the present invention. To facilitate interaction of a user with another user; an IP device 12, configured herein as an exemplary, but not limiting, video phone, includes video components such as a camera 24, for capturing the communicative expression of a user and further includes a display or monitor 26 for displaying the communicative expressions originating from the other user. The IP device 12, in accordance with an embodiment of the present invention, may further include a keypad 28 or other data entry device configured to enable the user to initiate a communication session in a conventional manner by entering a telephone number of the called user which may include an IP address, and is stored in storage 19 and captured therein as a called party number 32. The call from IP device 12 may be initiated through data entry similar to inputting a telephone number on a conventional telephone or through the input of an IP address through a graphical interface.

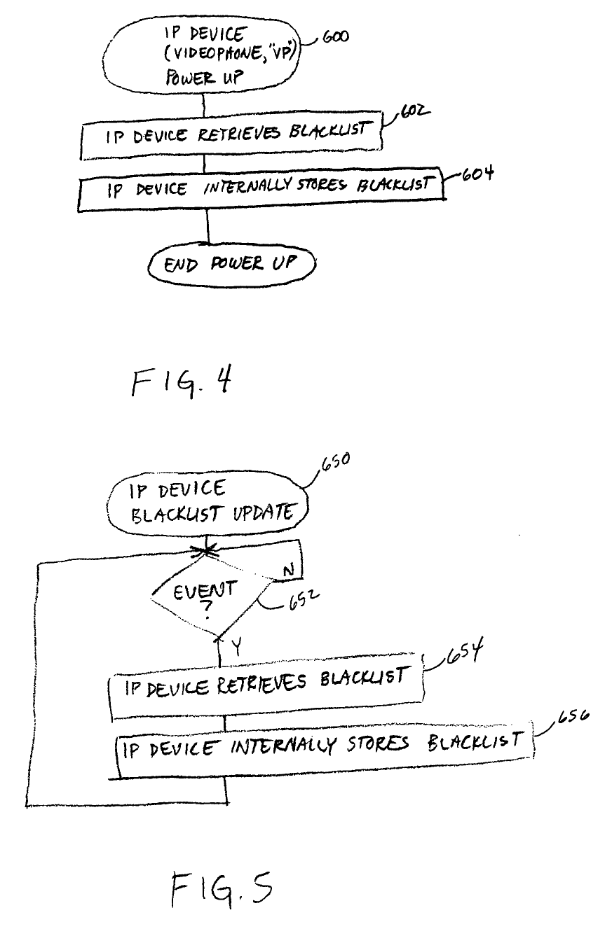

A control process 30 may initiate the retrieval or update of a blacklist 500 by retrieving a blacklist IP address 504 and initiating the retrieval of the blacklist 500 located within the blacklist database 502 through network 17. Upon retrieval, IP device 12 stores a copy of the blacklist 500 as blacklist 500′ for comparison when initiating communication sessions as directed by a user. The specific flow processes related to the comparison of an input IP address or domain name with those stored within the blacklist 500′ will be further discussed below with reference to FIGS. 4-6.

In the exemplary associated service described herein, the control process 30 retrieves a stored service number 34 which may be associated with a specific IP address 202 or domain name 201. In another configuration, the IP address 202 or domain name 201 may identify a specific associated service which is looked-up using a protocol such as DNS or LDAP contacts a DNS or an LDAP server 200 and passes thereto a domain name or stored service number 34 and requests therefrom a corresponding IP address which is returned to IP device 12. IP device 12 thereafter initiates a call, upon the successful comparison against blacklist 500′, to associated service 20 over network 17 using, for example, the corresponding IP address 202 or the IP address returned from the LDAP server 200. Thereafter, control process 30 initiates a communication session over network 17 between IP device 12 and associated services 20.

By further example, and not limitation, the communication session between IP device 12 and associated service 20 may be more specifically initially connected to a hold server 44 within an associated service 20. Hold server 44 communicates with a VRS server 45 and when hold server 44 receives an inbound call in the form of a call request for the establishment of a communication session between IP device 12 and associated service 20, hold server 44 notifies VRS server 45 of the intention to establish a communication session between IP device 12 and a conventional phone 22. During the establishment of the communication session between IP device 12 and associated service 20, IP device 12 passes a call request including calling information to hold server 44. The call request is subsequently passed to VRS server 45 including the calling information which includes a video phone number 204, a MAC address 206, a name 208 and the captured call party number 32. The VRS server 45 includes and maintains a cue for one or more calls originating from the IP device 12 seeking to establish or maintain a communication session utilizing, for example, interpretive services as provided within the VRS client 36.

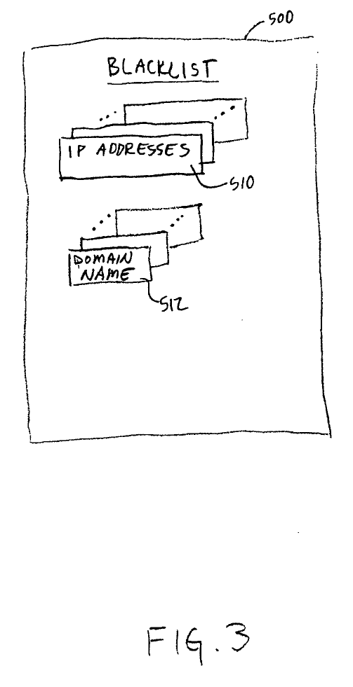

FIG. 3 is a block diagram of a blacklist and its contents, in accordance with an embodiment of the present invention. The blacklist 500 is updated and maintained in a blacklist database 502 (FIG. 2) and includes one or more entries of specific identifiers configured to uniquely identify a specific network address. By way of example, and not limitation, blacklist 500 may include one or more IP addresses 510 which uniquely identify one or more network resources that have been previously identified as restricted access by the IP device 12 (FIGS. 1-2) configured according to the various embodiments of the present invention. Additionally, blacklist 500 may further contain one or more domain names 512 which may be further mapped to a specific IP address identifying a unique network resource. Those of ordinary skill in the art appreciate that network resources may be recognizably identified by a specific domain name which resolves into a specific IP address identifying the ultimate addressed network resource. While it may appear that utilization of a single type of blacklist identifier, namely an IP address, may be adequate for identifying the network resource that is to become blacklisted, it is also appreciated that the various network resource entities may maintain a readily recognizable domain name while periodically changing the IP address corresponding with the domain name. Therefore, such a rogue service could periodically remove itself from the IP addresses of the blacklist by merely reassigning a new corresponding IP address to the domain name.

FIG. 4 is a flow diagram illustrating the sequencing of an IP device during power up process 600, in accordance with an embodiment of the present invention. An IP device, an example of which is a video phone, receives power as applied thereto and in accordance with the present invention, retrieves 602 a blacklist 500 (FIG. 2) over the network 17 (FIG. 2) from a blacklist database 502 (FIG. 2). The blacklist 500 (FIG. 2) is retrieved utilizing the blacklist IP address 504 (FIG. 2) stored within the IP device 12 during a configuration process. Upon receipt of the blacklist 500, the IP device internally stores 604 the blacklist 500 as received from the blacklist database 502 as a copy of the blacklist 500′ for subsequent comparison during call initiation processes.

FIG. 5 is a flow diagram of an IP device blacklist update process 650 configured to maintain a current version or retrieve an updated version of the blacklist 500′, in accordance with an embodiment of the present invention. It is contemplated that the update process may be driven by one or more events including time based/periodic update events, call initiation events by the IP device, a notification process to the IP device of a newer available version of the blacklist (e.g., email or other notification mechanism) or other event mechanisms as known by those of ordinary skill in the art. The update process 650 queries 652 for the occurrence of an update event and upon the detection of such an event the IP device retrieves 654 the blacklist 500 as stored on a blacklist database 502 (FIG. 2). The modification of the blacklist 500 within the blacklist database 502 (FIG. 2) may include update mechanisms known by those of ordinary skill in the art including the use of intelligence gathering mechanisms such as through the use of web crawlers, heuristic methods as well as industry knowledge by those of ordinary skill in the art. Such updated mechanisms for keeping the blacklist 500 current within the blacklist database 502 is not further discussed herein. Upon retrieval of a current version of the blacklist 500 from the blacklist database 502 (FIG. 2), the IP device internally stores 656 a copy of the blacklist 500′ within the IP device 12 (FIG. 2).

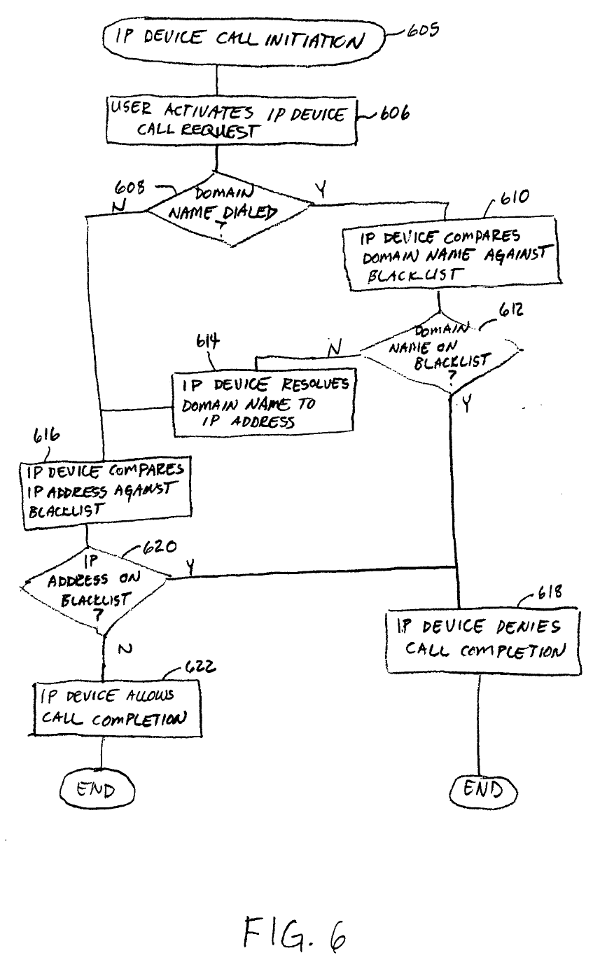

FIG. 6 is a flow diagram of an IP device call initiation process 605, in accordance with an embodiment of the present invention. Through user activation or otherwise, the IP device initiates a call request 606 which may include a specific identifier such as an entered IP address, domain name, or conventional phone number or name resolved into one of an IP address or domain name. The call initiation process determines 608 if the call was initiated using a domain name. If a domain name was utilized, the IP device compares 610 the domain name against the blacklist 500′ (FIG. 2) to determine 612 if the domain name is located within the blacklist 500′. If the domain name utilized for initiating the call is located with the blacklist 500′, then the IP device denies 618 the completion of the call and may alternatively notify the user of such denial. If the domain name is not on the blacklist, then the IP device resolves 614 the domain name into an IP address for further comparison.

The IP device compares 616 the IP address against the blacklist 500′ if either call initiation did not utilize a domain name in the call request as determined in query 608 or if the IP device was resolved 614 from a domain name to an IP address. Therefore, either the call initiated IP address or the domain name resolved IP address is compared 616 to determine 620 if the IP address is located within the blacklist 500′. If the IP address is located within the blacklist 500′, then the IP device denies 618 completion of the call. However, if the IP address is not located within the blacklist 500′, then the IP device allows 622 completion of the call.

Although the foregoing description contains many specifics, these are not to be construed as limiting the scope of the present invention, but merely as providing certain exemplary embodiments. Similarly, other embodiments of the invention may be devised which do not depart from the spirit or scope of the present invention. The scope of the invention is, therefore, indicated and limited only by the appended claims and their legal equivalents, rather than by the foregoing description. All additions, deletions, and modifications to the invention, as disclosed herein, which fall within the meaning and scope of the claims are encompassed by the present invention.

What is claimed is:

1. A method for blocking access to specific network resources, comprising:
receiving a request for a connection to a specific network resource as identified by a specific identifier;
comparing the specific identifier against entries in a stored blacklist, the blacklist including blocked network resource identifiers;
denying the connection to the specific network resource when the specific identifier matches one of the entries within the blacklist; and
allowing the connection to the specific network resource when the specific identifier does not match one of the entries within the blacklist.

2. The method of claim 1, further comprising retrieving an updated copy of the stored blacklist from a blacklist database upon the occurrence of an update event.

3. The method of claim 2, wherein the event is one of a periodic event, a notification event, a power-up event and the request for a connection event.

4. The method of claim 2, wherein retrieving an updated copy includes forming a connection with a blacklist database according to a stored blacklist IP address.

5. The method of claim 1, wherein the specific identifier is one of a domain name and an IP address.

6. The method of claim 5, further comprising resolving the domain name to a corresponding IP address when the specific identifier is a domain name.

7. The method of claim 1, wherein the entries of the stored blacklist include at least one entry for a network resource blacklisted in preference to a preferred network resource designated by a stored service number.

8. An network device, comprising:
a first portion of storage configured to retain a list of entries in a stored blacklist, the blacklist including blocked network resource identifiers; and
a control process configured to receive and compare a request for a connection to a specific network resource as identified by a specific identifier against the list of entries in the stored blacklist including blocked network resource identifiers, the control process further configured to deny the connection to the specific network resource when the specific identifier matches one of the entries within the blacklist and allow the connection to the specific network resource when the specific identifier does not match one of the entries within the blacklist.

9. The network device of claim 8, further comprising a second portion of storage configured to retain a stored blacklist IP address and the control process is further configured to retrieve an updated copy of the stored blacklist from a blacklist database upon the occurrence of an update event.

10. The network device of claim 9, wherein update events includes one of a periodic event, a notification event, a power-up event and the request for a connection event.

11. The network device of claim 9, wherein the control process is further configured to form a connection with a blacklist database according to a stored blacklist IP address to retrieve the updated copy of the stored blacklist from the blacklist database.

12. The network device of claim 8, wherein the specific identifier is one of a domain name and an IP address.

13. The network device of claim 12, wherein the control process is further configured to resolve the domain name to a corresponding IP address when the specific identifier is a domain name.

14. The network device of claim 8, wherein the entries of the stored blacklist include at least one entry for a network resource blacklisted in preference to a preferred network resource designated by a stored service number.

15. A system for selectively blocking access to specific network services, comprising:
a network device including:
storage configured to store entries in a stored blacklist, the blacklist including blocked network resource identifiers; and
a control process configured to receive and compare a request for a connection to a specific network resource as identified by a specific identifier against the list of entries in the stored blacklist including blocked network resource identifiers, the control process further configured to deny the connection to the specific network resource when the specific identifier matches one of the entries within the blacklist and allow the connection to the specific network resource when the specific identifier does not match one of the entries within the blacklist;
an associated service preferably selected by the network device, the network device further including a stored service number to identify the associated service; and
a network selectively addressably coupling the network device with the associated service.

16. The system of claim 15, wherein the control process is further configured to retrieve an updated copy of the stored blacklist from a blacklist database upon the occurrence of an update event.

17. The system of claim 16, wherein the event is one of a periodic event, a notification event, a power-up event and the request for a connection event.

18. The system of claim 15 wherein the storage is further configured to retain a stored blacklist IP address and the control process is further configured to retrieve an updated copy by forming a connection with a blacklist database according to the stored blacklist IP address.

19. The system of claim 15, wherein the specific identifier is one of a domain name and an IP address.

20. The system of claim 15, wherein the entries of the stored blacklist include at least one entry for a network resource blacklisted in preference to the associated service designated by a stored service number.
